(19) United States
(12) Patent Application Publication
(10) Pub. No.: US 2026/0044997 A1
(43) Pub. Date: Feb. 12, 2026

(54) SPEECH RECOGNITION-BASED IMAGE GENERATION SYSTEM AND METHOD

(71) Applicants: HYUNDAI MOTOR COMPANY, Seoul (KR); Kia Corporation, Seoul (KR)

(72) Inventors: Yicheng FAN, Shandong (CN); Sungbo YANG, Hwaseong-si (KR); Yao YAO, Shandong (CN)

(73) Assignees: HYUNDAI MOTOR COMPANY, Seoul (KR); Kia Corporation, Seoul (KR)

(21) Appl. No.: 19/279,324

(22) Filed: Jul. 24, 2025

(30) Foreign Application Priority Data
Aug. 6, 2024 (CN) 202411070216.5

(51) Int. Cl. G06T 11/00; G06F 40/30; G06N 3/0455; G10L 15/26

(52) U.S. Cl. CPC G06T 11/00; G06F 40/30; G06N 3/0455; G10L 15/26

(57) ABSTRACT

Disclosed are a system and a method of generating an image based on speech recognition. The system of generating an image based on speech recognition includes: a speech recognition apparatus configured to acquire speech information of a user, and convert the acquired speech information into text type user requirement information; a language understanding apparatus electrically connected to the speech recognition apparatus, and configured to analyze the text type user requirement information and extract semantic information of the user; a cloud image generation apparatus connected to be communicable with the language understanding apparatus, and configured to generate image data based on the extracted semantic information of the user by using a stability diffusion algorithm; and a display apparatus connected to be communicable with the cloud image generation apparatus, and configured to receive an image generated from the cloud image generation apparatus, and decode and display the received image.

### CROSS-REFERENCE TO RELATED APPLICATION

This application claims priority to and the benefit of Chinese Patent Application No. 202411070216.5 filed with the SIPO on Aug. 6, 2024, the entire contents of which are incorporated herein by reference.

### BACKGROUND OF THE DISCLOSURE

### (a) Field of the Disclosure

The present disclosure relates to an information processing technology field, and more particularly, to a system and a method of generating an image based on speech recognition.

### (b) Description of the Related Art

Currently, there are a problem in that result accuracy and consistence in which only an existing resource which exists on the Internet cannot be acquired are limited when a user searches for an Internet image and a video resource through speech and web crawling technology, a problem in that data acquisition is limited in which all resources cannot be acquired due to a crawling prevention mechanism, a data quality and copyright problem in which contents having low quality and ambiguity, or infringing copyrights, and personal information protection and security risk problem in which user information can be leaked, and a problem of recognition errors and semantic understanding in a direction of user experience and interaction.

In related art, since there are difficulties in the Internet image and the video resource, accuracy of speech recognition and association of a search result are enhanced by introducing further developed machine learning models and algorithms to generate high-quality images and video resources, thereby gradually improving such a problem, and more accurate, stable, and higher-quality services are provided to enhance a user experience.

The description of the background art is to provide convenience to deeply understand the technical measures of the present disclosure (used technical means, technical problems to be solved, and obtained technical effects, etc.), and it should not be construed that it is recognized or implied in any form that the information configures prior art known to those skilled in the art.

### SUMMARY OF THE DISCLOSURE

The present disclosure attempts to provide a system and a method of generating an image based on speech recognition, which may generate a unique image work according to a speech input of a user.

An exemplary embodiment of the present disclosure provides a system of generating an image based on speech recognition, which includes: a speech recognition apparatus configured to acquire speech information of a user, and convert the acquired speech information into text type user requirement information; a language understanding apparatus electrically connected to the speech recognition apparatus, and configured to analyze the text type user requirement information and extract semantic information of the user; a cloud image generation apparatus connected to be communicable with the language understanding apparatus, and configured to generate image data based on the extracted semantic information of the user by using a stability diffusion algorithm; and a display apparatus connected to be communicable with the cloud image generation apparatus, and configured to receive an image generated from the cloud image generation apparatus, and decode and display the received image.

Preferably, the speech recognition apparatus includes a speech input module configured to capture a speech signal of the user, a preliminary processing module configured to perform noise reduction, filtering, and speech enhancement with respect to the speech signal of the user, and acquire a preliminarily processed speech signal, a digital signal conversion module configured to convert the preliminarily processed speech signal into a digital signal, and perform spectrum analysis for the converted digital signal to acquire a spectrum feature, a feature extraction module configured to extract speech feature information from the spectrum feature, a speech recognition module configured to perform sequence modeling for the extracted speech feature information, and predict a speech unit for each time step, and output the predicted speech unit, and a postprocessing module configured to perform postprocessing for the predicted speech unit output by the speech recognition module, and generate final text type user requirement information.

Preferably, the digital signal conversion module is configured to perform the spectrum analysis with respect to the digital signal converted by using a discrete Fourier transform and/or a cepstrum analysis, the speech feature information includes a mel-frequency cepstrum coefficient and/or filter bank feature, and the postprocessing includes speech-unit connection, grammar correction, and semantic analysis.

Preferably, the language understanding apparatus includes a vocabulary analysis module configured to recognize and analyze a word structure for the text type user requirement information, and decompose a text into paragraphs, phrases, and words, a grammar analysis module configured to examine a grammar of the text, and arrange the decomposed paragraphs, phrases, and words, a semantic analysis module configured to map a syntax structure and a target in a task domain, and analyze a meaning of the text, an articulation integration module configured to determine meanings of a pronoun and a unique noun according to a relationship between a context of a sentence and pre and post sentences, and a pragmatic analysis module configured to extract and output semantic information of the user according to a cooperative dialogue, word repetition, and a conversion context.

Preferably, the cloud image generation apparatus includes an image generation module based on the stability diffusion algorithm, and the image generation module based on the stability diffusion algorithm is configured to convert a text into an expression form by using a CLIP model, input the expression form of the text into a U-Net model, and perform a diffusion process by a low-dimensional expression in the U-Net model, and input an image of the diffused low-dimensional expression in a decoder part of a variational auto encoder to generate a final image.

Preferably, the cloud image generation apparatus includes a video generation module based on the stability diffusion algorithm, and the video generation module based on the stability diffusion algorithm is configured to randomly sample a latent code, apply a DDIM backward step to the randomly sampled latent code, and acquire a designated motion field of each frame by using a pretrained stability diffusion model, calculate and generate a global transmission vector in order to control a global motion, deliver a latent code by applying the global motion and a DDPM forward process, deliver the latent code the stability diffusion model by using a cross-attention mechanism to generate an image frame, and combine all generated image frames in a time order to generate a final video.

Another exemplary embodiment of the present disclosure provides a method of generating an image based on speech recognition, which includes: acquiring, by a speech recognition apparatus, speech information of a user, and converting the acquired speech information into text type user requirement information; analyzing, by a language understanding apparatus, the text type user requirement information to extract semantic information of the user; generating, by a cloud image generation apparatus, image data based on the extracted semantic information of the user by using a stability diffusion algorithm; and receiving, by a display apparatus, an image generated from the cloud image generation apparatus, and decoding and displaying the received image.

Preferably, the acquiring of the speech information of the user, and converting the acquired speech information into the text type user requirement information includes capturing a speech signal of the user, performing noise reduction, filtering, and speech enhancement with respect to the speech signal of the user, and acquiring a preliminarily processed speech signal, converting the preliminarily processed speech signal into a digital signal, and performing spectrum analysis for the converted digital signal to acquire a spectrum feature, extracting speech feature information from the spectrum feature, performing sequence modeling for the extracted speech feature information, and predicting a speech unit for each time step, and outputting the predicted speech unit, and generating final text type user requirement information by performing postprocessing with respect to the predicted speech unit.

Preferably, the spectrum analysis is performed with respect to the digital signal converted by using a discrete Fourier transform and/or a cepstrum analysis, the speech feature information includes a mel-frequency cepstrum coefficient and/or filter bank feature, and the postprocessing includes speech-unit connection, grammar correction, and semantic analysis.

Preferably, the analyzing of the text type user requirement information to extract the semantic information of the user includes recognizing and analyzing a word structure for the text type user requirement information, and decomposing a text into paragraphs, phrases, and words, examining a grammar of the text, and arranging the decomposed paragraphs, phrases, and words, mapping a syntax structure and a target in a task domain, and analyzing a meaning of the text, determining meanings of a pronoun and a unique noun according to a relationship between a context of a sentence and pre and post sentences, and extracting and outputting semantic information of the user according to a cooperative dialogue, word repetition, and a conversion context.

Preferably, the generating of the image data based on the extracted semantic information of the user by using the stability diffusion algorithm includes converting a text into an expression form by using a CLIP model, inputting the expression form of the text into a U-Net model, and performing a diffusion process by a low-dimensional expression in the U-Net model, and inputting an image of the diffused low-dimensional expression in a decoder part of a variational auto encoder to generate a final image.

Preferably, the generating of the image data based on the extracted semantic information of the user by using the stability diffusion algorithm includes randomly sampling a latent code, applying a DDIM backward step to the randomly sampled latent code, and acquiring a designated motion field of each frame by using a pretrained stability diffusion model, defining a global scene and a camera motion direction, calculating and generating a global transmission vector in order to control a global motion, delivering the latent code by applying the global motion and a DDPM forward process, delivering the latent code the stability diffusion model by using a cross-attention mechanism to generate an image frame, and combining all generated image frames in a time order to generate a final video.

The present disclosure adopts the above technical measures and has the following beneficial effects:
1. Privacy: Since video work with uniqueness can be generated by using a speech input of a user as a guide, user's needs for content creativity and customization can be satisfied.
2. Provision of flexibility and customization: The user can define a style, a theme and a plot of a video through a speech command so that the generated video contents can reflect the user's personal preference and needs. This customized experience has enhanced the user's interaction quality and reinforced a charm of a product.
3. Provision of creativity: Using a learning and generation ability of a large model, it is possible to explore and create fresh video contents to promote innovative development in the field of visual media.
4. Solving copyright problems: In the process of generating images and videos, the use of materials which are under copyright protection is prevented to reduce the risk of infringement of rights, thereby ensuring the legal and safety of content.

Therefore, the system and the method of generating images and videos based on speech recognition of the present disclosure not only provide a completely new content creation method, but also provide a richer and personalized media experience for a user, and at the same time, show unique advantages in terms of copyright protection.

### BRIEF DESCRIPTION OF THE DRAWINGS

Hereinafter, exemplary embodiments of the present disclosure will be described with reference to the drawings. For a clear explanation, the same member in different drawings is represented by the same reference numeral. With respect to a point to be described, the drawings are just exemplary, and elements to be described are not particularly drawn according to a ratio.

FIG. 1 is a block diagram illustrating a system of generating an image based on speech recognition according to an exemplary embodiment of the present disclosure.

FIG. 2 is a block diagram illustrating a speech recognition apparatus in the system of generating an image based on speech recognition according to an exemplary embodiment of the present disclosure.

FIG. 3 is a block diagram illustrating a language understanding apparatus in the system of generating an image based on speech recognition according to an exemplary embodiment of the present disclosure.

FIG. 4 is a flowchart illustrating that an image generation module based on a stability diffusion algorithm of the system of generating an image based on speech recognition is generated according to an exemplary embodiment of the present disclosure.

FIG. 5 is a diagram illustrating a processing process of the image generation module based on the stability diffusion algorithm of the system of generating an image based on speech recognition according to an exemplary embodiment of the present disclosure.

FIG. 6 is a flowchart illustrating that a video generation module based on the stability diffusion algorithm of the system of generating an image based on speech recognition generates a video according to another exemplary embodiment of the present disclosure.

FIG. 7 is a diagram illustrating a processing process of the video generation module based on the stability diffusion algorithm of the system of generating an image based on speech recognition according to another exemplary embodiment of the present disclosure.

FIG. 8 is a flowchart illustrating a method of generating an image based on speech recognition according to an exemplary embodiment of the present disclosure.

FIG. 9 is a diagram for describing a computing apparatus according to an exemplary embodiment of the present disclosure.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and all claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various components, but the components are not limited by the terms. The terms are used only to discriminate one component from another component.

Terms including “part’, “˜er”, “module”, and the like disclosed in the specification mean a unit that can process at least one function or operation and this may be implemented by hardware or a circuit, or software or a combination of hardware or the circuit and software.

Hereinafter, exemplary embodiments of the present disclosure will be described with reference to drawings.

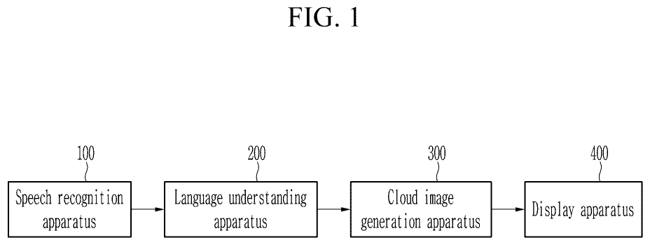

FIG. 1 is a block diagram illustrating a system of generating an image based on speech recognition according to an exemplary embodiment of the present disclosure.

Referring to FIG. 1, the system of generating an image based on speech recognition according to an exemplary embodiment of the present disclosure may include a speech recognition apparatus 100, a language understanding apparatus 200, a cloud image generation apparatus 300, and a display apparatus 400. According to an exemplary embodiment of the present disclosure, the system may include a processor (e.g., computer, microprocessor, CPU, ASIC, circuitry, logic circuits, etc.) and an associated non-transitory memory storing software instructions which, when executed by the processor, provides the functionalities of at least one of the speech recognition apparatus 100, the language understanding apparatus 200, the cloud image generation apparatus 300, and the display apparatus 400. Herein, the memory and the processor may be implemented as separate semiconductor circuits. Alternatively, the memory and the processor may be implemented as a single integrated semiconductor circuit. The processor may embody one or more processor(s).

The speech recognition apparatus 100 may acquire user speech information, and convert the acquired speech information into text type user requirement information. The language understanding apparatus 200 may be electrically connected to the speech recognition apparatus 100, and the language understanding apparatus 200 may analyze the text type user requirement information, and extract semantic information of a user.

The cloud image generation apparatus 300 may be connected to be communicable with the language understanding apparatus, and the cloud image generation apparatus 300 may be configured to generate image data based on the extracted semantic information of the user.

The display apparatus 400 may be connected to be communicable with the cloud image generation apparatus 300, and the display apparatus 400 may receive, decode, and display the image generated by the cloud image generation apparatus. In some embodiments, the display apparatus 400 may include, but is not limited to, TVs, computer monitors, smartphones, tablets, wearable displays (e.g., smart glasses, VR/AR headsets, etc.), head-up displays (HUDs), control panel displays.

According to an exemplary embodiment of the present disclosure, the communicable connection may be connections through a wired communication and/or wireless communication scheme. The wired communication scheme may include Controller Area Network (CAN), Local Interconnect Network (LIN), Universal Serial Bus (USB), High Definition Multimedia Interface (HDMI), Digital Visual Interface (DVI), etc. Here, the CAN may include a power train CAN bus P_CAN, a vehicle body control device CAN bus B_CAN, a chassis control CAN bus C_CAN, etc., but the CAN communication scheme is not limited to the CAN bus communication scheme. The wireless communication scheme may include a global mobile communication system, a code division multiple access, a wideband code division multiple access, a universal mobile communication system, a time division multiple access, a long-term evolution, etc.

Hereinafter, a specific configuration of each apparatus in the system of generating an image based on speech recognition according to an exemplary embodiment of the present disclosure will be described in detail.

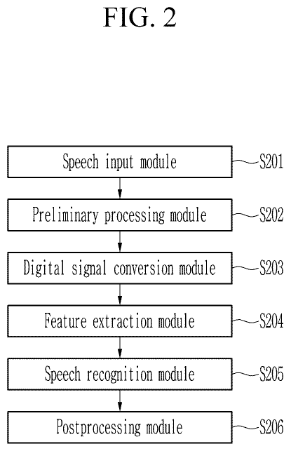

FIG. 2 is a block diagram illustrating a speech recognition apparatus in the system of generating an image based on speech recognition according to an exemplary embodiment of the present disclosure.

Referring to FIG. 2, the speech recognition apparatus (e.g., speech recognition apparatus 100) may include a speech recognition module 201, a preliminary processing module 202, a digital signal conversion module 203, a feature extraction module 204, a speech recognition module 205, and a post-processing module 206. According to an exemplary embodiment of the present disclosure, the speech recognition apparatus may include a processor (e.g., computer, microprocessor, CPU, ASIC, circuitry, logic circuits, etc.) and an associated non-transitory memory storing software instructions which, when executed by the processor, provides the functionalities of at least one of the speech recognition module 201, the preliminary processing module 202, the digital signal conversion module 203, the feature extraction module 204, a speech recognition module 205, and the post-processing module 206. Herein, the memory and the processor may be implemented as separate semiconductor circuits. Alternatively, the memory and the processor may be implemented as a single integrated semiconductor circuit. The processor may embody one or more processor(s).

The speech input module 201 may capture a speech signal of the user, and the speech input module 201 may include a microphone or other audio input devices, and converts the speech signal of the user into a processible electrical signal.

The preliminary processing module 202 performs preliminary processing including a manipulation, such as noise reduction, filtering, and speech enhancement with respect to the speech signal of the user to enhance a quality of the speech signal. This assists further clarifying the speech signal by removing surrounding noise and removing echo and other disturbance elements.

The digital signal conversion module 203 converts a preliminarily processed speech signal into a digital signal, and performs spectrum analysis for the converted digital signal to acquire a spectrum feature. The digital signal conversion module 203 converts the preliminarily processed speech signal (analog signal) into the digital signal by using an analog-digital converter (ADC), and then performs the spectrum analysis with respect to the digital signal by using a discrete Fourier transform (DFT) and/or cepstrum analysis to obtain a spectrum and energy distribution information.

The feature extraction module 204 may extract speech feature information from the spectrum feature. The speech feature information may include a mel-frequency cepstrum coefficient (MFCC) and/or a filter bank feature (FBANK). The MFCC may effectively capture frequency characteristics of the speech signal, and show an expression ability for a note and a tone of a speech, and an FBANK feature may provide information related to a speech signal energy distribution, so information of the speech signal, such as frequency, energy and sound features of the speech signal may be acquired through the speech feature information.

The speech recognition module 205 may predict a speech unit (e.g., phoneme or grapheme) for each time step by performing sequence modeling for input speech feature information, and output the predicted speech unit. The speech recognition module 205 may be realized by using a deep learning model such as a recurrent neural network (RNN), along and short term memory network (LSTM), or a transformer.

The postprocessing module 206 may be configured to perform postprocessing for the predicted speech unit output by the speech recognition module, and generate final text type use requirement information. The postprocessing may include speech-unit connection, grammar correction, and semantic analysis.

The speech recognition apparatus according to an exemplary embodiment of the present disclosure converts the speech signal of the user into a corresponding test result through a cooperation task of the module to realize conversion from the speech to the text.

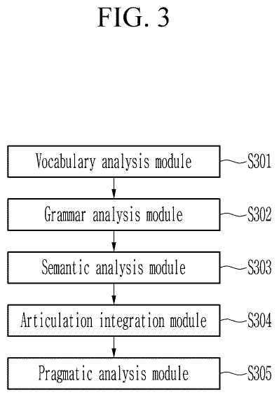

FIG. 3 is a block diagram illustrating a language understanding apparatus in the system of generating an image based on speech recognition according to an exemplary embodiment of the present disclosure.

The language understanding apparatus in the system of generating an image based on speech recognition according to an exemplary embodiment of the present disclosure uses a natural language understanding (NLU) algorithm, and the NLU algorithm may deeply understand a meaning of a user command, and provide accurate data foundation for a subsequent system response. The NLU algorithm divides the user command into three levels, i.e., domain, intent, and slot.

After receiving a command input by the user, the NLU algorithm first determines to which specific application field or category the command belongs. This step assists the system to understand a context of the command. Subsequently, the algorithm additionally analyzes the command to identify a specific intent of the user, i.e., any task to be executed or any information to be acquired by the user. Last, the system extracts core information during the command, and fills a predefined word slot with the extracted core information. The word slot indicates specific information required for completing a specific intent such as a time, a place, a target, etc.

Referring to FIG. 3, the language understanding apparatus (e.g., language understanding apparatus 200) may include a vocabulary analysis module 301, a grammar analysis module 302, a semantic analysis module 303, an articulation integration module 304, and a pragmatic analysis module 305. According to an exemplary embodiment of the present disclosure, the language understanding apparatus may include a processor (e.g., computer, microprocessor, CPU, ASIC, circuitry, logic circuits, etc.) and an associated non-transitory memory storing software instructions which, when executed by the processor, provides the functionalities of at least one of the vocabulary analysis module 301, the grammar analysis module 302, the semantic analysis module 303, the articulation integration module 304, and the pragmatic analysis module 305. Herein, the memory and the processor may be implemented as separate semiconductor circuits. Alternatively, the memory and the processor may be implemented as a single integrated semiconductor circuit. The processor may embody one or more processor(s).

The vocabulary analysis module 301 may recognize and analyze a word structure for the text type user requirement information, and decompose a text into paragraphs, phrases, and words. This is a first step of language understanding, which constructs a foundation for subsequent grammar and semantic analysis.

The grammar analysis module 302 examines a grammar of the text, and arrays the decomposed paragraphs, phrases, and words to ensure the word structure of the text accurately, and allocates a conversion according to the word structure of the text to allow a subsequent module to better understand text information.

The semantic analysis module 303 may analyze a meaning of the text by mapping a syntax structure and a target in a task domain, and the module focuses on analyzing literal meanings of a sentence, a phrase, and a word.

The articulation integration module 304 may determine implicit meanings of a pronoun and a unique noun according to a relationship between a context of the sentence, and prior and post sentences. This assists removing ambiguity and ensuring accuracy of language understanding.

The pragmatic analysis module 305 may extract and output semantic information of the user according to a cooperative dialogue, word repetition, and a conversion context. This assists better understanding an intent and a requirement by considering an actual situation of language use.

Since the language understanding apparatus in the system of generating an image based on speech recognition according to an exemplary embodiment of the present disclosure may deeply understand and analyze text information of the user through the cooperative task of the module, the language understanding apparatus may accurately determine the requirement and the intent of the user.

The cloud image generation apparatus according to an exemplary embodiment of the present disclosure may be a cloud server, and the language understanding apparatus may transmit the converted text to the cloud server through a cloud request and an API call. The cloud server performs cloud large model processing by using deep learning technology. A large model learns large amounts of image and text data to understand a semantic and a context of the text, and generate visual contents which match a text description. Further, the cloud image generation apparatus according to an exemplary embodiment of the present disclosure may also be a local server, and only if the present disclosure may generate image contents which match the text description, the present disclosure is not limited thereto.

The cloud image generation apparatus according to an exemplary embodiment of the present disclosure may realize generating an image in a text by using the image generation model such as the stability diffusion algorithm. The stability diffusion algorithm as a technology for an image generation and enhancement task, which is based on a concept of a diffusion process of repeatedly updating a pixel value, and gradually converting the updated pixel value into a desired output.

In response, the cloud image generation apparatus may include an image generation module based on the stability diffusion algorithm. The image generation module based on the stability diffusion algorithm applies a series of diffusion steps from an initial image, and adjusts the pixel value according to a difference between adjacent pixels in each step to soften noise and enhance an image detail. A diffusion process is continuously repeated several times until reaching a required image quality or enhancement level.

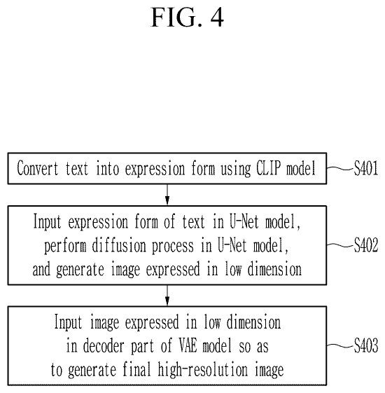

FIG. 4 is a flowchart illustrating that an image generation module based on a stability diffusion algorithm of the system of generating an image based on speech recognition is generated according to an exemplary embodiment of the present disclosure.

Referring to FIG. 4, in S401, the image generation module based on the stability diffusion algorithm converts a text into an expression form by using a contrastive language-image pretraining (CLIP) model, i.e., encodes an input text through the CLIP model to obtain an expression form such as a text. The CLIP model as a model that is developed by OpenAI converts the text into the text form to facilitate performing similarity search or other semantic tasks.

In S402, the expression form of the text is input into a U-Net model, and a diffusion process is performed by a low-dimensional expression (64×64) in the U-Net model. First, the U-Net model is constructed, and the model is a convolutional neural network for image generation, but the present disclosure is not limited to the machine learning model. Thereafter, the expression form of the text is input into the U-Net model, and the diffusion process is performed in the U-Net model, and noise and a detail are gradually enhanced to generate an image which is expressed in a low dimension (64×64).

In S403, an image expressed in the low dimension after diffusion is input into a decoder part of a variational autoencoder (VAE) model. The VAE model is constructed, and the model includes two parts, i.e., an encoder and a decoder. The image expressed in the low dimension after diffusion is input into a VAE recorder. The image expressed in the low dimension is decoded through a VAE decoder to generate a final high-resolution image.

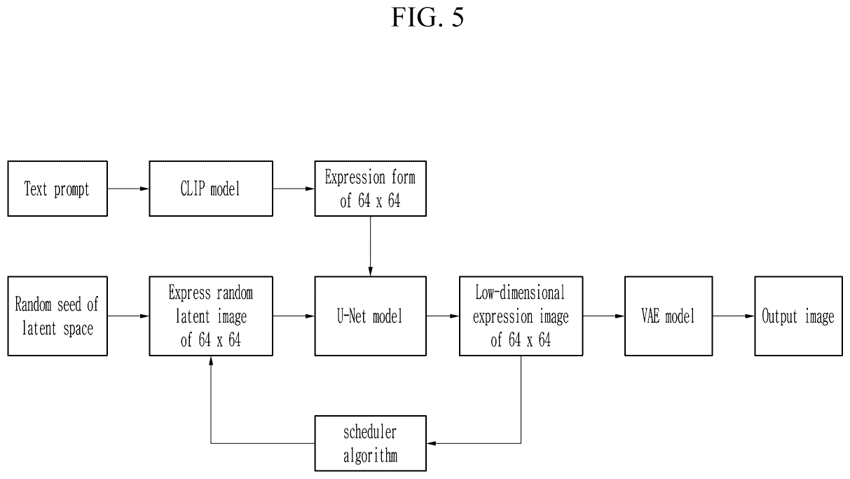

FIG. 5 is a diagram illustrating a processing process of the image generation module based on the stability diffusion algorithm of the system of generating an image based on speech recognition according to an exemplary embodiment of the present disclosure.

Referring to FIG. 5, the image generation module based on the stability diffusion algorithm simultaneously inputs a random seed and a text prompt of a latent space, and then generates a random latent image expression having a size of 64×64 by using a seed of the latent space, and converts the text prompt input through a text encoder of CLIP into the expression form having the size of 64×64. Thereafter, the expression form of 64×64 is set as a condition by using the U-Net model, and at the same time, noise removal is performed repeatedly with respect a random latent image expression. An output of the U-Net model is a residue of noise, and is used for calculating a latent image expression from which noise is removed through a scheduler algorithm. The scheduler algorithm calculates a predicted image expression from which noise is removed according to a previous noise expression and a predicted noise residue.

In the image generation module based on the stability diffusion algorithm according to an exemplary embodiment of the present disclosure, the U-Net model works in a low-dimensional space, which reduces a memory and a calculation complexity by compared with a pixel space diffusion. Accordingly, the image generation module based on the stability diffusion algorithm according to an exemplary embodiment of the present disclosure may rapidly effectively realize generating an image in a text, and this provides a better solving method for a task of generating the image with a speech, and brings a new possibility to an infotainment application.

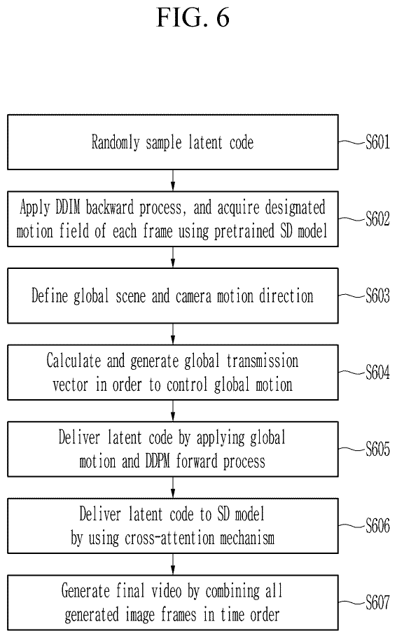

According to another exemplary embodiment of the present disclosure, the cloud image generation apparatus may include a video generation module based on the stability diffusion algorithm so as to realize a task of converting a zero sample text into a video. FIG. 6 is a flowchart illustrating that a video generation module based on the stability diffusion algorithm of the system of generating an image based on speech recognition is generated according to another exemplary embodiment of the present disclosure.

Referring to FIG. 6, in step S601, a latent code X randomly sampled is first started, for example, a first frame code is randomly sampled, and such a code serves as a start point of a generation process.

In step S602, a denoising diffusion implicit model (DDIM) backward process is applied to the randomly sampled latent code X, and a designated motion field of each frame K is acquired by using a pretrained stability diffusion (SD) model.

The DDIM backward process starts the generation process according to an initial condition (randomly sampled latent code X). Thereafter, by using the SD model, generation or modification of a video frame is guided according to a predetermined condition (e.g., a text description or a core frame). As a result, the SD model provides a “motion field” required for DDIM, i.e., a series of operation and change parameters, and the parameters define a change scheme between the video frames to realize a smooth and consistent motion effect.

In step S603, a global scene and a camera motion direction are defined. In the case of each frame K, a motion of an object in a scene is simulated by designating one motion field. The motion field derives rotation of a distortion function to reinforce the latent code through motion dynamics, determine a global scene and a camera motion, and guarantees a time consistency of a background and the global scene.

In step S604, a global transmission vector is calculated and generated for controlling a global motion amount.

In step S605, the latent code X is transferred by applying a global motion and a denoising diffusion probabilistic model (DDPM) forward process, and this method provides a larger degree of freedom to an object motion.

In step S606, the latent code X is delivered to the stability diffusion (SD) model by using a cross-attention mechanism. In order to maintain a consistency between an appearance and an identity of a foreground object in a video sequence, the cross-attention mechanism is used. Such a mechanism allows the model to share information in different frames, thereby guaranteeing the consistency in a video of an object.

The SD model generates an image in which frame K=1 by using a key and a value during a first frame. This process guarantees the generated image to coincide with the text description, and conserves the appearance and the identity of the foreground object in an entire video sequence through the cross-attention mechanism.

In step S607, all generated image frames are temporally combined to generate a final video.

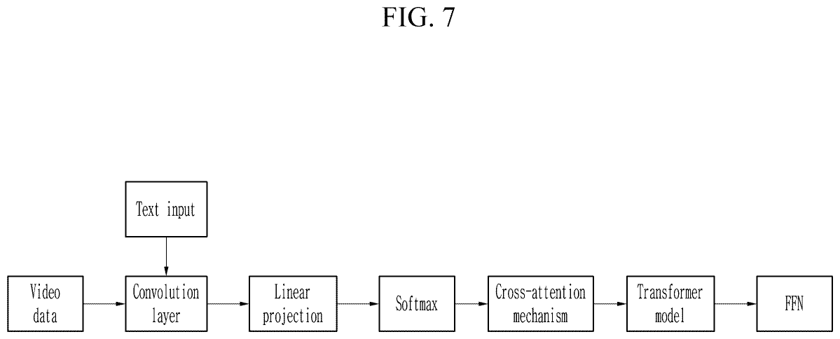

FIG. 7 is a diagram illustrating a processing process of the video generation module based on the stability spread algorithm of the system of generating an image based on speech recognition according to another exemplary embodiment of the present disclosure.

Referring to FIG. 7, video data is preliminarily processed, and then a visual feature is extracted by using a convolution layer. The extracted visual feature is adjusted to a format suitable for a transformer model through a linear projection. At the same time, a text input is also converted into a high-dimensional vector expression through similar processing (i.e., the visual feature is extracted through the convolution layer, and then adjusted to the format suitable for the transformer model through the linear projection). Thereafter, by using the cross-attention mechanism, the text input is guided to process a video feature to realize a semantic alignment between both sides. Such a process is repeated several times, and a next optimal video frame is predicted by combination with Softmax to gradually construct final video contents.

When the image or the video data is processed, the convolution layer is used for feature extraction. In the case of generating the video in the text, when the image or the video frame is included in an input, the convolution layer may extract a meaningful visual feature in initial pixel data. First, the video frame is processed by a series of image sequences, and then convolution kernels having different sizes and types are slid in such an image by using a filter to detect different visual modes (e.g., edges, textures, etc.), and downsampling is performed according to a convolution manipulation through pooling to reduce a data dimension and at the same time, maintain a main feature.

When the extracted feature is converted into a form suitable for subsequent transformer model processing, a dimension of a feature vector is adjusted, and a weight matrix W is applied to each feature vector through a weight matrix multiplication to convert a dimension to coincide with a desired input format of the transformer model.

The Softmax is used for an output layer so as to generate a probability distribution of each type. Here, the Softmax is used for generating the probability distribution of the text description or classifying a target type in the video frame. A score is calculated for each available output type, and then the score is converted into the probability distribution by using a Softmax function, and a sum of all probabilities is guaranteed to become 1.

According to an exemplary embodiment of the present disclosure, the SD model may include the transformer model and a feed forward network (FFN). Further, implementation of the SD model may be different.

The transformer model as a sequence model based on a self-attention mechanism may be used for processing a natural language processing task. The transformer model is generally used for the encoder part of the SD model, and converts the randomly sampled code X into a low-dimensional latent space, and this latent space includes information and noise of the image. The FFN is generally used for extracting and predicting the feature in the latent space, and generally used in the decoder part of the SD model, and removes noise in the latent space to generate a high-quality image. The FFN additionally processes the processed feature by self-attention and cross-attention, and introduces non-linearity and enhances an expression ability of the model. An input of the FFN is first activated through linear conversion (generally, by using ReLU), and then restores a required output dimension through second linear conversion. Residual connection and layer normalization is used for stable training, and an output of the FFN is generally added to the input (residual connection), and then the layer normalization is applied to the output of the FFN.

The SD model combines advantages of the transformer and the FFN to realize high-efficiency application in an image synthesis video generation field. The SD model processes the text prompt by using the transformer, and makes an image detail be further detailed by using the FFN to finally generate a high-quality image.

In an entire process, the stability diffusion algorithm provides a probability framework for gradually generating the video frame in a situation in which the text prompt is given. The algorithm ensures the generated video and the input text to maintain the consistency semantically in addition to considering the visual quality of the video contents.

According to an exemplary embodiment of the present disclosure, the text description is converted into a series of image frames to create a video which coincides with the text description. Such a process generates the video from the text description to realize a zero sample text-video task in a situation in which there is no direct video sample.

According to an exemplary embodiment of the present disclosure, since the generated image (image and/or video) may be transmitted through a streaming transmission protocol, the image is guaranteed to be rapidly and stably transmitted to the display apparatus 400. This may be related to partitioning, compressing, and transmitting the video stream by using the streaming transmission protocol (e.g., RTSP or HLS) to be adapted to different network conditions and bandwidth limitations.

The display apparatus 400 may be configured to receive, decode, and display the image generated from the cloud image generation apparatus. The display apparatus may decode image data to a recognizable image sequence by using a video decoding technology, and this may be related to decoding the image by using a video codec (e.g., H.264 or H.265) so as to convert initial image data. Thereafter, the display apparatus displays a decoded image sequence so as to be viewed by a user. The display apparatus may use a high-resolution display screen and an image processing chip, and provides a better visual experience, and guarantees high-quality regeneration and fluency of the video through image processing techniques (e.g., image augmentation, color correction, and frame speed control). According to an exemplary embodiment of the present disclosure, the display apparatus may be all apparatuses which may display an image, such as a vehicle mounted display apparatus and a cellular phone screen.

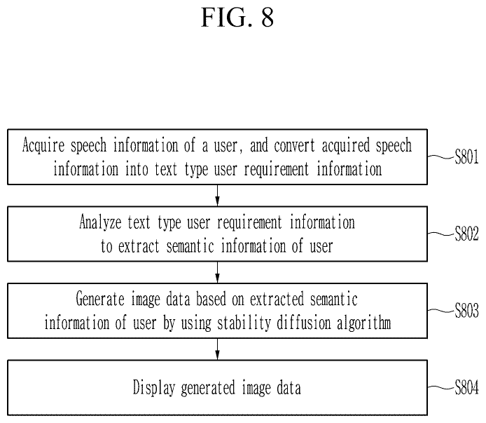

According to an exemplary embodiment of the present disclosure, a method of generating an image based on speech recognition is further provided, and FIG. 8 is a flowchart illustrating a method of generating an image based on speech recognition according to an exemplary embodiment of the present disclosure.

Referring to FIG. 8, in step S801, the speech recognition apparatus acquires speech information of a user, and converts the acquired speech information into text type user requirement information.

In step S802, the text type user requirement information is analyzed by a language understanding apparatus to extract semantic information of the user. The language understanding apparatus extracts the semantic information of the user by using a natural language processing technology.

In step S803, a cloud image generation apparatus uses a stability diffusion algorithm to generate image data based on the extracted semantic information of the user.

In step S804, the display apparatus receives an image from the cloud image generation apparatus, and decodes and displays the received image.

Through the step, the method of generating the image based on speech recognition may convert speech information of the user into corresponding image contents, and display the converted image contents in the display apparatus. The technology may be applied to various scenes such as fields such as smart home control, virtual reality, entertainment, etc.

When the system and the method of generating the image based on speech recognition according to exemplary embodiments of the present disclosure are applied to a vehicle, that is, the speech recognition apparatus, the language understanding apparatus, and the display apparatus are installed in the vehicle, and when a passenger says one word in the vehicle, the speech recognition apparatus converts the said word into the text form. Subsequently, the language understanding apparatus processes and converts the text so as to better understand an intent and a requirement of the passenger. The language understanding apparatus may convert the text into a structuralized data expression for subsequent processing and understanding. Through a cloud request and an API call, the converted text may be transmitted to the cloud image generation apparatus.

The cloud image generation apparatus performs cloud large-scale model processing by using deep learning technology. This includes generating a corresponding image or video contents according to the text of the passenger by using the stability diffusion algorithm and a deep generation model (for example, a model such as generative adversarial networks (GAN) or a variational autoencoder (VAE)). The generated image or video contents are transmitted through the streaming transmission protocol to guarantee the image to be rapidly and stably transmitted to the vehicle mounted display apparatus.

In the vehicle mounted display apparatus, a video reception module is responsible for receiving a delivered image or video data. Thereafter, the video decoding module decodes the video data with a recognizable image sequence. Last, the image or video is displayed to the passenger, and the passenger may set the image as a background screen, and regenerate the video, etc., and such a function may provide more personalization options, so the passenger may customize and set an image or a video liked thereby according to a preference thereof.

The system and the method of generating the image based on speech recognition according to exemplary embodiments of the present disclosure may be creative and personalized, and generate a unique video work according to a speech input and a speech command of the user. The user may customize and set a style, a theme, and a plot of the video through the speech command. Further, creation and search are promoted and video contents which are creative and have not yet seen previously are created by using learning and generation abilities of a large-scale model. At the same time, by solving copyright issues, a right infringement problem related to use of image and video resources which are subjected to copyright protection is also prevented.

In various exemplary embodiments of the present disclosure, all possible combinations are not listed, but the representative aspects of the present disclosure are described, and the contents described in various embodiments may be applied independently or in two or more combinations.

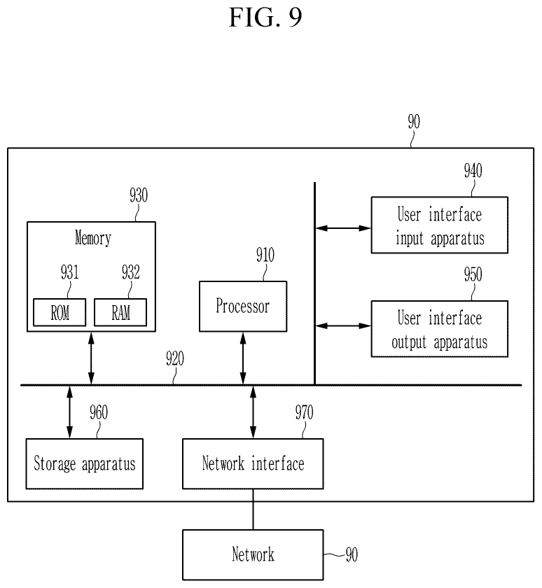

FIG. 9 is a diagram for describing a computing device according to an exemplary embodiment of the present disclosure.

Referring to FIG. 9, the system and the method of generating the image based on speech recognition according to exemplary embodiments may be implemented by using the computing device 900.

The computing device 900 may include at least one of a processor 910, a memory 930, a user interface input device 940, a user interface output device 950, and a storage device 560 which communicate with each other through a bus 920. The computing device 900 may also include a network interface 970 electrically connected to a network 90. The network interface 970 may transmit or receive a signal to or from another entity through the network 90.

The processor 910 may be implemented as various types including a micro controller unit (MCU), an application processor (AP), a central processing unit (CPU), a graphic processing unit (GPU), and a neural processing unit (NPU), and may be an arbitrary semiconductor device that executes an instruction stored in the memory 930 or the storage device 960. The processor 910 may be configured to implement the functions and methods in relation to FIGS. 1 to 8.

The memory 930 and the storage device 960 may be various types of volatile or non-volatile storage media. For example, the memory may include a read only memory (ROM) 931 and a random access memory (RAM) 932. In the exemplary embodiment, the memory 930 may be positioned inside or outside the processor 930 and connected to the processor 910 by various well-known means.

In some exemplary embodiments, at least some components or functions of the system and the method of generating the image based on speech recognition according to exemplary embodiments may be implemented as a program or software executed by the computing device 900 or the program or software may be stored in a non-transitory computer readable medium.

In some exemplary embodiments, at least some components or functions of the system and the method of generating the image based on speech recognition according to exemplary embodiments may be implemented by using hardware or a circuit of the computing device 900 or also implemented as a separate hardware or circuit which may be electrically connected to the computing device 900.

While this disclosure has been described in connection with what is presently considered to be practical exemplary embodiments, it is to be understood that the disclosure is not limited to the disclosed exemplary embodiments. On the contrary, it is intended to cover various modifications and equivalent arrangements included within the spirit and scope of the appended claims.

What is claimed is:

1. A system of generating an image based on speech recognition, comprising:
a speech recognition apparatus configured to acquire speech information of a user, and convert the acquired speech information into text type user requirement information;
a language understanding apparatus electrically connected to the speech recognition apparatus, and configured to analyze the text type user requirement information and extract semantic information of the user;
a cloud image generation apparatus connected to be communicable with the language understanding apparatus, and configured to generate image data based on the extracted semantic information of the user by using a stability diffusion algorithm; and
a display apparatus connected to be communicable with the cloud image generation apparatus, and configured to receive an image generated from the cloud image generation apparatus, decode the received image, and display the decoded image.

2. The system of claim 1, wherein:
the speech recognition apparatus includes,
a speech input module configured to capture a speech signal of the user,
a preliminary processing module configured to perform noise reduction, filtering, and speech enhancement with respect to the speech signal of the user, and acquire a preliminarily processed speech signal,
a digital signal conversion module configured to convert the preliminarily processed speech signal into a digital signal, and perform spectrum analysis for the converted digital signal to acquire a spectrum feature,
a feature extraction module configured to extract speech feature information from the spectrum feature,
a speech recognition module configured to perform sequence modeling for the extracted speech feature information, and predict a speech unit for each time step, and output the predicted speech unit, and
a postprocessing module configured to perform postprocessing for the predicted speech unit output by the speech recognition module, and generate final text type user requirement information.

3. The system of claim 2, wherein:
the digital signal conversion module is configured to perform the spectrum analysis with respect to the digital signal converted by using a discrete Fourier transform and/or a cepstrum analysis,
the speech feature information includes a mel-frequency cepstrum coefficient or filter bank feature, and
the postprocessing includes speech-unit connection, grammar correction, and semantic analysis.

4. The system of claim 1, wherein:
the language understanding apparatus includes,
a vocabulary analysis module configured to recognize and analyze a word structure for the text type user requirement information, and decompose a text into paragraphs, phrases, and words,
a grammar analysis module configured to examine a grammar of the text, and arrange the decomposed paragraphs, phrases, and words,
a semantic analysis module configured to map a syntax structure and a target in a task domain, and analyze a meaning of the text,
an articulation integration module configured to determine meanings of a pronoun and a unique noun according to a relationship between a context of a sentence and pre and post sentences, and
a pragmatic analysis module configured to extract and output semantic information of the user according to a cooperative dialogue, word repetition, and a conversion context.

5. The system of claim 1, wherein:
the cloud image generation apparatus includes an image generation module based on the stability diffusion algorithm, and the image generation module based on the stability diffusion algorithm is configured to
convert a text into an expression form by using a CLIP model,
input the expression form of the text into a U-Net model, and perform a diffusion process by a low-dimensional expression in the U-Net model, and
input an image of the diffused low-dimensional expression in a decoder part of a variational auto encoder to generate a final image.

6. The system of claim 1, wherein:
the cloud image generation apparatus includes a video generation module based on the stability diffusion algorithm, and the video generation module based on the stability diffusion algorithm is configured to,
randomly sample a latent code,
apply a DDIM backward step to the randomly sampled latent code, and acquire a designated motion field of each frame by using a pretrained stability diffusion model,
define a global scene and a camera motion direction,
calculate and generate a global transmission vector in order to control a global motion,
deliver a latent code by applying the global motion and a DDPM forward process,
deliver the latent code the stability diffusion model by using a cross-attention mechanism to generate an image frame, and
combine all generated image frames in a time order to generate a final video.

7. A method of generating an image based on speech recognition, comprising:
acquiring, by a speech recognition apparatus, speech information of a user, and converting the acquired speech information into text type user requirement information;
analyzing, by a language understanding apparatus, the text type user requirement information to extract semantic information of the user;
generating, by a cloud image generation apparatus, image data based on the extracted semantic information of the user by using a stability diffusion algorithm; and
receiving, by a display apparatus, an image generated from the cloud image generation apparatus, decoding the received image and displaying the decoded image.

8. The method of claim 7, wherein:
the acquiring of the speech information of the user, and converting the acquired speech information into the text type user requirement information includes,
capturing a speech signal of the user,
performing noise reduction, filtering, and speech enhancement with respect to the speech signal of the user, and acquiring a preliminarily processed speech signal,
converting the preliminarily processed speech signal into a digital signal, and performing spectrum analysis for the converted digital signal to acquire a spectrum feature,
extracting speech feature information from the spectrum feature,
performing sequence modeling for the extracted speech feature information, and predicting a speech unit for each time step, and outputting the predicted speech unit, and
generating final text type user requirement information by performing postprocessing with respect to the predicted speech unit.

9. The method of claim 8, wherein:
the spectrum analysis is performed with respect to the digital signal converted by using a discrete Fourier transform and/or a cepstrum analysis,
the speech feature information includes a mel-frequency cepstrum coefficient or filter bank feature, and
the postprocessing includes speech-unit connection, grammar correction, and semantic analysis.

10. The method of claim 7, wherein:
the analyzing of the text type user requirement information to extract the semantic information of the user includes,
recognizing and analyzing a word structure for the text type user requirement information, and decomposing a text into paragraphs, phrases, and words,
examining a grammar of the text, and arranging the decomposed paragraphs, phrases, and words,
mapping a syntax structure and a target in a task domain, and analyzing a meaning of the text,
determining meanings of a pronoun and a unique noun according to a relationship between a context of a sentence and pre and post sentences, and
extracting and outputting semantic information of the user according to a cooperative dialogue, word repetition, and a conversion context.

11. The method of claim 7, where:
the generating of the image data based on the extracted semantic information of the user by using the stability diffusion algorithm includes,
converting a text into an expression form by using a CLIP model,
inputting the expression form of the text into a U-Net model, and performing a diffusion process by a low-dimensional expression in the U-Net model, and
inputting an image of the diffused low-dimensional expression in a decoder part of a variational auto encoder to generate a final image.

12. The method of claim 7, wherein:
the generating of the image data based on the extracted semantic information of the user by using the stability diffusion algorithm includes,
randomly sampling a latent code,
applying a DDIM backward step to the randomly sampled latent code, and acquiring a designated motion field of each frame by using a pretrained stability diffusion model,
defining a global scene and a camera motion direction,
calculating and generating a global transmission vector in order to control a global motion,
delivering the latent code by applying the global motion and a DDPM forward process,
delivering the latent code the stability diffusion model by using a cross-attention mechanism to generate an image frame, and
combining all generated image frames in a time order to generate a final video.

13. A non-transitory computer readable storage medium including a program stored thereon, wherein the program is configured to cause a computer to execute a method of generating an image based on speech recognition, the method comprising:
acquiring speech information of a user, and converting the acquired speech information into text type user requirement information;
analyzing the text type user requirement information to extract semantic information of the user;
generating image data based on the extracted semantic information of the user by using a stability diffusion algorithm; and
receiving the generated image, decoding the received image and displaying the decoded image.

14. The non-transitory computer readable storage medium according to claim 13, wherein the acquiring of the speech information of the user, and converting the acquired speech information into the text type user requirement information includes,
capturing a speech signal of the user,
performing noise reduction, filtering, and speech enhancement with respect to the speech signal of the user, and acquiring a preliminarily processed speech signal,
converting the preliminarily processed speech signal into a digital signal, and performing spectrum analysis for the converted digital signal to acquire a spectrum feature,
extracting speech feature information from the spectrum feature,
performing sequence modeling for the extracted speech feature information, and predicting a speech unit for each time step, and outputting the predicted speech unit, and
generating final text type user requirement information by performing postprocessing with respect to the predicted speech unit.

15. The non-transitory computer readable storage medium according to claim 14, wherein:
the spectrum analysis is performed with respect to the digital signal converted by using a discrete Fourier transform and/or a cepstrum analysis,
the speech feature information includes a mel-frequency cepstrum coefficient or filter bank feature, and
the postprocessing includes speech-unit connection, grammar correction, and semantic analysis.

16. The non-transitory computer readable storage medium according to claim 15, wherein the analyzing of the text type user requirement information to extract the semantic information of the user includes,
recognizing and analyzing a word structure for the text type user requirement information, and decomposing a text into paragraphs, phrases, and words,
examining a grammar of the text, and arranging the decomposed paragraphs, phrases, and words,
mapping a syntax structure and a target in a task domain, and analyzing a meaning of the text,
determining meanings of a pronoun and a unique noun according to a relationship between a context of a sentence and pre and post sentences, and
extracting and outputting semantic information of the user according to a cooperative dialogue, word repetition, and a conversion context.

17. The non-transitory computer readable storage medium according to claim 13, where the generating of the image data based on the extracted semantic information of the user by using the stability diffusion algorithm includes:
converting a text into an expression form by using a CLIP model,
inputting the expression form of the text into a U-Net model, and performing a diffusion process by a low-dimensional expression in the U-Net model, and
inputting an image of the diffused low-dimensional expression in a decoder part of a variational auto encoder to generate a final image.

18. The non-transitory computer readable storage medium according to claim 13, wherein the generating of the image data based on the extracted semantic information of the user by using the stability diffusion algorithm includes:
randomly sampling a latent code,
applying a DDIM backward step to the randomly sampled latent code, and acquiring a designated motion field of each frame by using a pretrained stability diffusion model,
defining a global scene and a camera motion direction,
calculating and generating a global transmission vector in order to control a global motion,
delivering the latent code by applying the global motion and a DDPM forward process,
delivering the latent code the stability diffusion model by using a cross-attention mechanism to generate an image frame, and
combining all generated image frames in a time order to generate a final video.
